(19) United States
(12) Patent Application Publication
(10) Pub. No.: US 2025/0087724 A1
(43) Pub. Date: Mar. 13, 2025

(54) FUEL CELL SYSTEM AND METHOD OF OPERATING A FUEL CELL SYSTEM

(71) Applicant: HOERBIGER ANTRIEBSTECHNIK HOLDING GMBH, Schongau (DE)

(72) Inventors: Felix ROTHE, Schongau (DE); Christoph Pfeiffer, Schongau (DE); Sebastian Sohmen, Schongau (DE); Christopher Traut, Schongau (DE)

(21) Appl. No.: 18/463,816

(22) Filed: Sep. 8, 2023

(51) Int. Cl. H01M 8/04089; B05B 1/20; H01M 8/04082

(52) U.S. Cl. CPC H01M 8/04097; B05B 1/20; H01M 8/04201; H01M 2250/20

(57) ABSTRACT

A fuel cell system has at least one fuel cell which includes an anode compartment and a cathode compartment, and a recirculation line for anode gas which leads from a gas outlet of the anode compartment to a gas inlet of the anode compartment and in which an ejector pump is arranged. The ejector pump includes a first nozzle and at least one second nozzle which is in the form of a ring nozzle arranged coaxially around the first nozzle. A respective fuel gas valve is associated with a respective nozzle and controls a supply of pressurized fuel gas to a primary gas inlet of the respective nozzle. In a low load range, only the first or only the at least one second nozzle of the ejector pump is selectively supplied with primary gas, whereas in a high load range both nozzles are supplied with primary gas simultaneously.

### TECHNICAL FIELD

The disclosure relates to a fuel cell system, in particular in a drive system of a motor vehicle, and to a method of operating a fuel cell system.

### BACKGROUND

Fuel cells can be used to generate electric current, typically by a fuel gas (e.g., hydrogen or a hydrogen-containing gas mixture) supplied to the anode compartment of the fuel cell reacting chemically with an oxygen-containing gas mixture (e.g., ambient air) supplied to the cathode compartment of the fuel cell to form a reaction product (e.g., water). In a known form of fuel cell, the anode compartment is separated from the cathode compartment by an electrolyte membrane.

In order to ensure a sufficient supply of fuel gas to the anode, the fuel gas is usually fed so as to be leaner than stoichiometric. Furthermore, in order to reuse the fuel that has not been reacted, it is known to recirculate the anode gas, that is, to supply it to the anode compartment again in a circuit. To this end, the anode gas is extracted via a gas outlet of the anode compartment and subsequently supplied to the anode compartment again via a gas inlet of the anode compartment. To recirculate the anode gas, both electrically driven recirculating fans and ejector pumps driven by the pressurized fuel gas itself have been employed so far.

Compared with a recirculating fan, an ejector pump need not be driven using electrical energy, which benefits the energy efficiency of the fuel cell system. In addition, ejector pumps distinguish themselves by a long service life and high reliability, since they do not feature any moving parts that are susceptible to malfunction.

When using an ejector pump, the pressurized fuel gas serves as the propulsive primary gas. This gas is accelerated in a motive fluid nozzle and enters a mixing chamber of the ejector pump, forming a motive fluid jet. The anode gas supplied through a suction connection is entrained by the motive fluid jet, with a momentum being transferred from the motive fluid jet to the anode gas supplied, accelerating the latter. Therefore, the anode gas is sucked in and delivered back to the anode compartment in the recirculation line.

The ratio of the volume flow rates of recirculated anode gas to primary gas applied for this purpose is referred to as the recirculation rate.

The delivery rate of an ejector pump depends on the flow rate of the primary gas supplied. Therefore, the recirculation rate varies as a function of the load range of the fuel cell system. Typically, the recirculation rate decreases as the operating point of the fuel cell system is lowered toward lower load, that is, the smaller the amount of primary gas supplied becomes.

In addition, owing to the geometry of the ejector pump, the recirculated amount of gas is tightly dependent on the amount of hydrogen supplied via the primary gas. The recirculated portion cannot therefore be adjusted separately, as is the case with active recirculation by means of a fan.

The present disclosure improves a recirculation of anode gas in a fuel cell system using ejector pumps.

### SUMMARY

A fuel cell system according to the present disclosure includes at least one fuel cell which has an anode compartment and a cathode compartment, and including a recirculation line for anode gas which leads from a gas outlet of the anode compartment to a gas inlet of the anode compartment and in which an ejector pump is arranged, the ejector pump having a first nozzle and at least one second nozzle which is in the form of a ring nozzle arranged coaxially around the first nozzle, and including at least two fuel gas valves, each fuel gas valve being associated with a nozzle and controlling a supply of pressurized fuel gas to a primary gas inlet of the respective nozzle of the ejector pump.

The two fuel gas valves allow the amount of inflow to the two nozzles to be controlled individually. In this way, by pre-specifying the primary gas flow rate of the respective nozzle of the ejector pump, an adjustable pumping capacity for the recirculation line and thus a variation of the recirculation rate is possible.

The current primary flow rates of the individual nozzles can be set at different flow rates.

For example, the ejector pump is designed such that a maximum primary gas flow rate through the first nozzle is smaller than that through the second nozzle. The minimum diameter of the conventional first nozzle can simply be designed to be so small that the first nozzle develops a high suction power in the case of small current primary gas flow rates. The second nozzle, on the other hand, which is designed as a ring nozzle, is well suited for higher primary gas flow rates.

In a preferred embodiment, the ejector pump includes exactly one second nozzle. However, variants having a plurality of concentric second nozzles in the form of ring nozzles would also be conceivable.

The ejector pump develops its maximum throughput when there is a maximum primary gas flow through both the first nozzle and the second nozzle. This load point normally coincides with a fully open state of both fuel gas valves.

The primary gas inlet of the second nozzle may open into the annular chamber of the second nozzle, so that the primary gas is supplied to the ejector pump without further flow losses. In addition, a very compact design can be achieved in this way. If a plurality of ring nozzles are provided, which are all formed coaxially with one another, the primary gas ports of all ring nozzles may open into the respective annular chamber.

In order to reduce the installation space required by the fuel cell system, the two fuel gas valves may be integrated in the ejector pump. For example, the fuel gas valves may be arranged at an angle of between 10 degrees and 140 degrees, in particular 90 degrees, to each other. This also facilitates routing of the primary gas supply lines to the individual fuel gas valves.

To optimize the gas flow through the two nozzles, the two nozzles open axially into a suction chamber which is enlarged in comparison with the outside diameter of the second nozzle and into which the recirculation line from the gas outlet of the anode compartment opens laterally. The suction chamber is adjoined axially in the direction of flow, for example, by a mixing chamber and a diffuser.

All nozzles may open into the suction chamber at their minimum cross-sectional areas here.

In order that as variable a setting of the recirculation rate as possible can be achieved, at least one fuel gas valve should be a proportional valve and/or a valve operated in a clocked manner, which can be used to set a variable fuel gas flow rate through the respective fuel gas valve. In this case, the primary gas flow through the respective fuel gas valve is continuously controllable up to a predefined maximum gas passage.

For this purpose, specifically designed solenoid valves may be used, which allow both operating modes to be implemented by means of the frequency of the clocking. It is possible, for example, to govern the motive fluid jet generated by the motive fluid nozzle by means of a pulse-width modulated impingement of the fuel gas valve. In this case, the primary gas flow is interrupted at intervals and the motive fluid jet is controlled discontinuously rather than continuously, such that shut-off intervals without a primary gas flow, in which the respective fuel gas valve is closed, alternate with passage intervals with a high primary gas flow, in which the fuel gas valve is open. By way of adjusting the lengths of the shut-off intervals and the passage intervals (“pulse widths”), the primary gas flow over the load range can be adjusted as desired, averaged over a longer period of time. As a result of the clocked pumping action of the ejector pump, the motive fluid jet pulsating in accordance with the sequence of the shut-off and passage intervals here generates a correspondingly pulsating mixed gas flow consisting of recirculated anode gas and (fresh) fuel gas and entering the anode compartment, and a correspondingly pulsating anode gas flow exhausted from the anode compartment through the suction port. In a proportional operation, the fuel gas valve can be operated at a sufficiently high clock frequency to keep its valve element in a desired partially open state on a quasi-stationary basis due to its mass inertia. The current primary gas flow can be adjusted in both operating modes by means of the clock rate and the lengths of the shut-off intervals and the passage intervals.

In order to obtain a highest possible variability in the recirculation rate, the ejector pump should be designed such that it can be selectively operated with only one nozzle or simultaneously with two or, if required, more nozzles.

Typically, the fuel cell system includes a shut-off valve between the fuel gas source and the fuel gas valves in order to reliably prevent leakage flows. The shut-off valve may, for example, either be connected upstream of both fuel gas valves or may be formed by the first fuel gas valve.

According to a first variant of the fuel cell system, all of the fuel gas valves are connected in parallel so that primary gas can be supplied to each nozzle of the ejector pump independently of each other. In this context, each fuel gas valve should be connected to a pressurized fuel gas source in the same way.

In this case, the shut-off valve is provided in addition to the fuel gas valves and is arranged in the fluid communication between the fuel gas source and the fuel gas valves.

The maximum primary gas flow through each nozzle of the ejector pump, which each forms a portion of a maximum total primary gas flow through the ejector pump, may be specified either by a design-related maximum flow rate of the respective nozzle or by the respective associated fuel gas valve.

In this variant, all of the fuel gas valves are proportional valves or valves operated in a clocked manner, the flow rates of which can be continuously varied. Each of the fuel gas valves can then be continuously adjusted separately from a fully closed state to a fully open state. By adapting the rates of flow through the individual fuel gas valves and thus through the individual nozzles of the ejector pump, the recirculation rate can be individually adjusted over a wide range.

For example, the first fuel gas valve is set to a predefined maximum primary gas flow rate of up to 30%, in particular up to 20%, 15% or 10% of the maximum total primary gas flow rate. In other words, the first fuel gas valve, when fully open, allows the maximum proportion of the total primary gas flow of the fuel cell system to pass to which it is set.

The current total primary gas flow rate is obtained from the sum of the current primary gas flow rates of all fuel gas valves. This corresponds to the total quantity of fuel gas coming from the storage tank and currently routed into the anode compartment.

The second fuel gas valve (or the sum of all remaining fuel gas valves) is accordingly designed for the larger remaining quantity. For example, the maximum primary gas flow rate amounts to 70% to 90% of the maximum total primary gas flow rate.

Generally, the gas flows here each describe a quantity of gas flowing through per unit of time, that is, they are used here in the sense of a flow rate.

In accordance with a second variant of the fuel cell system, the first fuel gas valve is connected upstream of all further fuel gas valves, i.e. the second fuel gas valve and possibly further fuel gas valves, and a bypass line runs from the outlet of the first fuel gas valve to the ejector pump, parallel to all further fuel gas valves.

In this case, the first fuel gas valve always has to be at least partially open to allow operation of the ejector pump, since the primary gas flows through the first fuel gas valve to the second and possibly all further fuel gas valves. In this variant, the first fuel gas valve is advantageously configured as a shut-off valve, in particular as a two-position valve, which can only assume the “fully closed” and “fully open” states. In this way, an additional shut-off valve can be dispensed with, which saves installation space and costs.

The first fuel gas valve can be designed such that its maximum gas flow rate is larger than the maximum gas flow rate of the first nozzle. The maximum primary gas flow through the first nozzle is then limited by the design of the first nozzle.

The second fuel gas valve may be configured to be continuously adjustable. This also applies to any further fuel gas valves that may be present.

If the first nozzle is operated alone, only a single load point of the fuel cell system can be realized in this case. This point is e.g. between 5% and 30%, in particular at 8%.

As of this load point of the fuel cell system specified by the first nozzle, the primary gas flow rate is variably adjustable by the setting of the second fuel gas valve for higher flow rates.

In most cases, the fuel cell system comprises a plurality of fuel cells which are combined to form a stack. The recirculation line then splits e.g. accordingly into the individual anode gas inlets, with identical gas flows in parallel, and is combined again to a single line by the individual anode gas outlets.

Typically, the fuel cell system includes a fuel gas pressure tank and a pressure reducer connected between the fuel gas pressure tank and the shut-off valve. For example, the pressure downstream of the pressure reducer is about 10 bar to 16 bar (10,000 hPa to 16,000 hPa). In the recirculation line, normally an overpressure prevails relative to the environment, e.g., an absolute pressure of about 3 bar (3,000 hPa).

Fuel gas can be pressurized hydrogen. The primary gas may be pure hydrogen. The gas flowing back from the anode compartment in the recirculation line contains, in addition to hydrogen, water vapor, nitrogen and other impurities.

The reaction product formed during the chemical reaction accumulates for the most part in the cathode compartment. However, due to leaks within the fuel cell and undesirable side reactions, condensate water and foreign gases (particularly nitrogen) may also accumulate in the anode compartment, impairing the function of the fuel cell.

The fuel cell system therefore includes, as is conventionally known, at least one water separator and at least one purge valve in the recirculation line in order to allow condensed water as well as foreign gases and contaminants to be removed in a known manner. This is effected e.g. by separate purging cycles, which, however, are not relevant to the disclosure.

The above-mentioned object is also achieved by a method of operating a fuel cell system as described above. In a low load range, only the first or only the at least one second nozzle of the ejector pump is supplied with primary gas, and in a high load range, both nozzles are supplied with primary gas simultaneously.

The first nozzle is e.g. designed for a smaller maximum primary gas flow rate than the second nozzle and serves the low load range in particular. The second nozzle is designed for a higher load range than the first nozzle. Where a plurality of second nozzles, i.e. a plurality of ring nozzles, are present, their cross-sectional areas can be adapted accordingly to cover higher load ranges. In the high load range, a plurality or all of the nozzles are operated at the same time.

For example, in the low load range only the first or only the second nozzle of the ejector pump is operated, whereas in the high load range both nozzles are operated simultaneously.

In the low load range, that is, at low current primary gas flow rates, it may be advantageous to operate only the first nozzle, since this nozzle produces a higher throughput at lower primary gas flow rates than the second nozzle.

In a fuel cell system according to the first variant, it can optionally be selected in the low load range which of the two nozzles of the ejector pump is to be operated alone, depending on the situation.

The supply of fuel gas to the respective primary gas inlet of the individual nozzles is advantageously freely controllable within the scope of a characteristic map, the characteristic map being determined by predefined maximum primary gas flow rates of the fuel gas valves associated with the respective nozzles. This also results in a characteristic map for the recirculation rate to be set. To move to specific points of the characteristic map, the current primary gas flow rates through the individual nozzles of the ejector pump are adjusted accordingly by means of the degree of opening of the individual fuel gas valves.

The two fuel gas valves can each be opened continuously here from the fully closed state up to their maximum specified degree of opening in order to continuously adjust the current primary gas flow rate. In this way, the current total primary gas flow rate can also be continuously adjusted from zero to the predefined maximum total primary gas flow rate.

For example, in the low load range, the first nozzle can be operated up to the specified maximum proportion of the maximum total primary gas flow rate. As from this point, the second nozzle may be activated additionally, so that in the high load range both nozzles of the ejector pump are operated.

In another mode, initially only the second nozzle is operated, and when its maximum primary gas flow rate is reached as the load increases, the first nozzle is additionally activated to cover the high load range up to the maximum total primary gas flow rate.

It would also be conceivable, when passing through the load range and starting at zero or at the minimum possible load point, to first operate only the first nozzle, then to operate only the second nozzle, and finally to operate both nozzles together in the high load range.

Other points of the characteristic map can be moved to, e.g., by a joint operation of all nozzles of the ejector pump with freely selected current primary gas flow rates through the individual nozzles.

Depending on the allocation of the current total primary gas flow to the individual fuel gas valves, the current recirculation rate can thereby be changed in accordance with the characteristic map.

In a fuel cell system according to the second variant as described above, the characteristic map is reduced to a single curve which starts at the (single) load point that is established by the opening of the first fuel gas valve and operating the first nozzle alone, and is passed through up to the maximum by continuously opening the second fuel gas valve up to its maximum degree of opening.

### BRIEF DESCRIPTION OF THE DRAWINGS

FIG. 1 shows a schematic representation of a fuel cell system according to a first variant of the disclosure;

FIG. 2 shows a schematic representation of the fuel gas valves and the ejector pump of the fuel cell system of FIG. 1;

FIG. 3 shows a schematic view of an ejector pump for use in a fuel cell system according to the disclosure;

FIG. 4 shows a schematic representation of a fuel cell system according to a second variant of the disclosure;

FIG. 5 shows a schematic representation of the fuel gas valves and the ejector pump of the fuel cell system of FIG. 4; and

FIG. 6 shows a characteristic map generated by the recirculation rate of a fuel cell system according to the disclosure.

### DETAILED DESCRIPTION

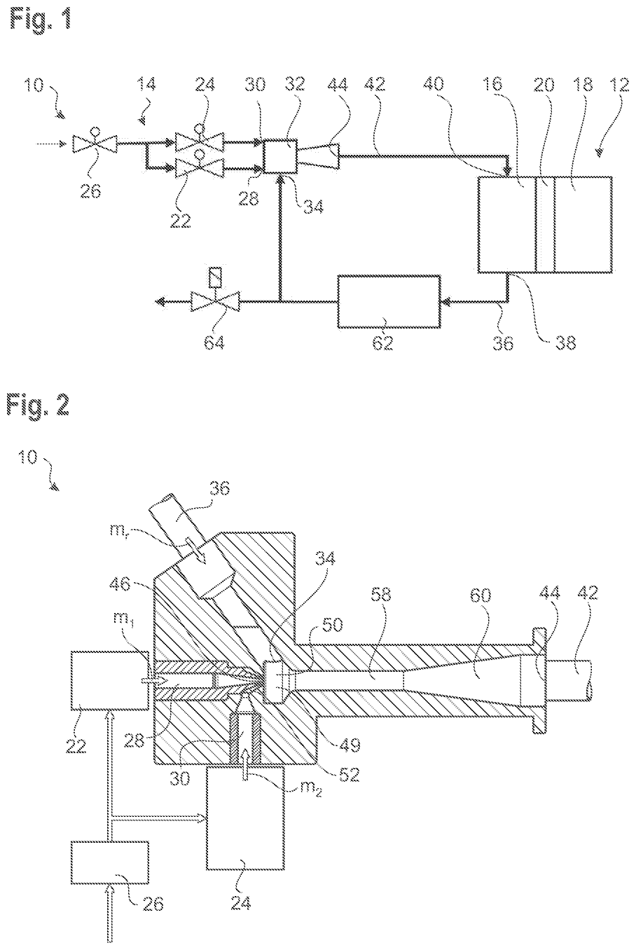

FIG. 1 shows a fuel cell system 10 according to a first variant, having at least one fuel cell 12 and a fuel gas supply 14. Only a single fuel cell 12 is depicted in FIG. 1. Usually, a plurality of fuel cells 12 of the same type are combined to form a stack. But this is not relevant for the description of the disclosure.

The fuel cell system 10 provides, for example, operating power in a drive system of a motor vehicle. It may, however, also be designed for other applications.

The fuel cell 12 includes an anode compartment 16 and a cathode compartment 18, which are separated from each other by a membrane 20, in this case an electrolyte membrane.

In the example considered here, the fuel used is hydrogen. It is supplied in a gaseous form to the anode compartment 16. Gaseous oxygen is provided in the cathode compartment 18, for example by passing ambient air through the cathode compartment 18.

However, the disclosure can also be put into practice using other fuels.

The fuel gas supply 14 comprises a storage pressure tank for the fuel gas and a pressure reducer in fluid communication therewith, which specifies an output pressure for the feeding of the fuel to the fuel cell 12 (not illustrated). When the fuel used is hydrogen, the output pressure is, for example, approximately between 10 and 16 bar (10,000 to 16,000 hPa).

The pressure reducer is in fluid communication with first and second fuel gas valves 22, 24, which are connected in parallel. Fuel gas is conducted from the storage pressure tank to the fuel cell 12 via the two fuel gas valves 22, 24. The same pressure is always applied to the respective input side of the two fuel gas valves 22, 24.

A shut-off valve 26 is connected upstream of both fuel gas valves 22, 24 and is connected in terms of flow between the pressure reducer and the two fuel gas valves 22, 24.

The shut-off valve 26 is a two-position valve and can only assume the “fully closed” and “fully open” switching states. It need not perform any further pressure-limiting function in relation to the pressure reducer, so that the pressure supplied by the pressure reducer is fully applied to the two fuel gas valves 22, 24 when the shut-off valve 26 is open.

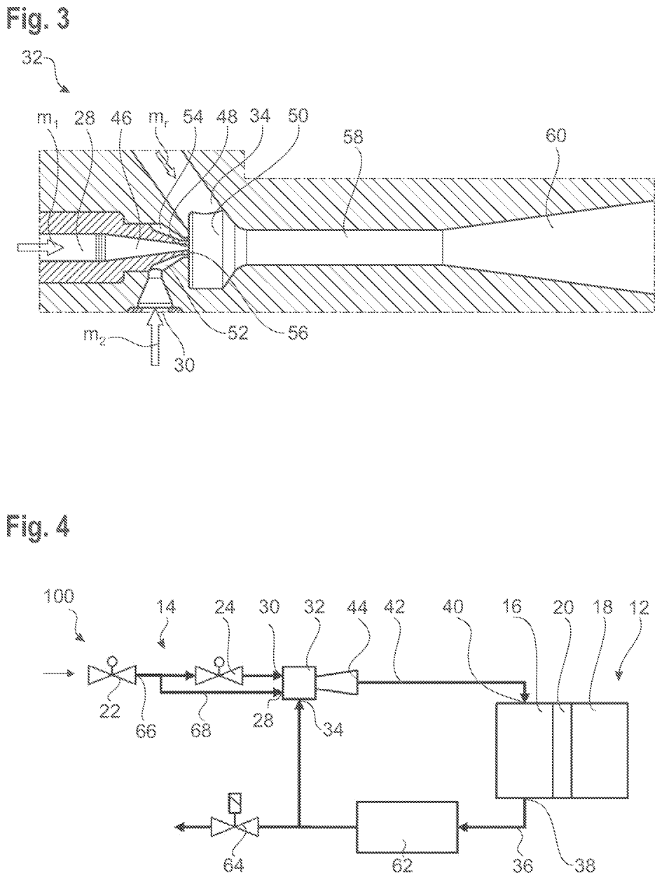

Each of the two fuel gas valves 22, 24 is connected to a respective primary gas inlet 28, 30 of a (single) ejector pump 32. The fuel gas flowing into the ejector pump 32 through the respective primary gas inlet 28, 30 is used to generate a suction power of the ejector pump 32 at a single suction inlet 34 (see also FIGS. 2 and 3).

The ejector pump 32 is connected via the suction inlet 34 to a recirculation line 36, which leads from a gas outlet 38 of the anode compartment 16 via the ejector pump 32 back to a gas inlet 40 of the anode compartment 16. From the gas outlet 38, the anode gas is first conducted to the suction inlet 34 of the ejector pump 32. A mixture of recirculated anode gas and pure, freshly fed-in fuel gas is conducted from an outlet 44 of the ejector pump 32 to the gas inlet 40 of the anode compartment 16 via a section 42 of the recirculation line 36.

FIG. 3 shows the ejector pump 32, which is configured as an ejector, in greater detail.

The primary gas inlet 28 ends in a first nozzle 46 that is configured as a conventional nozzle, the minimum cross-sectional area 48 of which contributes to determining a flow velocity of a motive fluid jet exiting there. Provided that the pressure upstream of the nozzle 46 is sufficiently high, the flow velocity in the minimum cross-sectional area 48 reaches the speed of sound.

The motive fluid jet reaches its highest flow velocity shortly downstream of the nozzle 46. This flow velocity can be adjusted through the design of the ejector pump 32 and may be up to several times the speed of sound.

Downstream of the minimum cross-sectional area 48, the flow path widens radially to form a suction chamber 50 of the ejector pump 32. The suction inlet 34 opens radially into the suction chamber 50 immediately downstream of the narrowest point of the first nozzle 46.

The primary gas inlet 30 leads to a second nozzle 52 of the ejector pump 32. The second nozzle 52 is in the form of a ring nozzle and has an annular chamber 54 which coaxially surrounds the first nozzle 46 (see FIG. 3). The primary gas inlet 30 opens into the second nozzle 52.

The second nozzle 52 also subsequently opens into the suction chamber 50 at its minimum cross-sectional area 56.

The suction chamber 50 continues axially into a mixing chamber 58 having a reduced cross-section compared to the suction chamber 50. The primary gas flowing through the nozzles 46, 52 thus passes through the suction chamber 50 to arrive in the mixing chamber 58. In the mixing chamber 58, the primary gas supplied via the nozzles 46, 52 mixes with the recirculated gas from the anode compartment 16.

In the direction of flow, the mixing chamber 58 is adjoined here by a diffuser 60, in which the gas flow is expanded and adjusted to the pressure in the subsequent section 42 of the recirculation line 36.

The first fuel gas valve 22 is exclusively in fluid communication with the first nozzle 46 of the ejector pump 32, while the second fuel gas valve 24 is exclusively in fluid communication with the second nozzle 52 of the ejector pump 32.

The total gas flow, which is composed of the current primary gas flow m₁ through the first nozzle 46, the current primary gas flow m₂ through the second nozzle 52, and the gas m, from the anode compartment 16 currently recirculated through the recirculation line 36, enters from the outlet 44 of the ejector pump 32 into the section 42 of the recirculation line 36 that leads to the gas inlet 40 of the anode compartment 16.

The minimum cross-sectional area 56 of the second nozzle 52 is larger than the minimum cross-sectional area 48 of the first nozzle 46, so that a maximum possible gas flow through the second nozzle 52 is generally larger than a maximum possible gas flow through the first nozzle 46.

In this variant, both fuel gas valves 22, 24 are proportional valves and/or clocked valves. This results in their current primary gas flow rate being continuously adjustable between zero and a predefined maximum primary gas flow rate m_{1,max}, m_{2,max}. The maximum primary gas flow rates form portions of a maximum total primary gas flow rate m_{1,max}+m_{2,max}.

In this example, the two fuel gas valves 22, 24 are each integrated in the ejector pump 32, with the two fuel gas valves 22, 24 being arranged at an angle of about 90 degrees to each other in this case.

Here, the fuel gas valves 22, 24 are designed as clocked solenoid valves which are closed during shut-off intervals and open during passage intervals. Therefore, they can provide a pulsed propellant gas flow.

Optionally, both fuel gas valves 22, 24 may also be operated in a proportional mode, in which the clock frequency is selected to be high enough that a valve element of the respective fuel gas valve 22, 24 assumes a quasi-stationary position that corresponds to a predefined degree of opening of the valve. In this way, a substantially continuous adjustment of the primary gas flow rate through the respective fuel gas valve 22, 24 from zero up to its respective predefined maximum primary gas flow rate m_{1,max}, m_{2,max} is possible.

The pressure in the anode compartment 16 and in the recirculation line 36 is, for example, set at an elevated level compared to the ambient pressure and may be, e.g., about 3 bar (3,000 hPa) absolute.

As is conventionally known, the recirculation line 36 also comprises one or more water separators 62 to discharge liquid water, and one or more purge valves 64 to remove gas from the recirculation line 36.

A recirculation rate mᵣ/mₚ is defined by the ratio of the current flow rate mᵣ of recirculated anode gas from the recirculation line 36 through the suction inlet 34 to the current primary gas flow rate mₚ, i.e. the sum of the current primary gas flow rates m₁+m₂ of primary gas flowing through the primary gas inlets 28, 30 of the ejector pump 32.

The recirculation rate is directly dependent on the amount of primary gas currently flowing through the respective nozzle 46, 52 of the ejector pump 32, thus defining a current pumping power of the ejector pump 32.

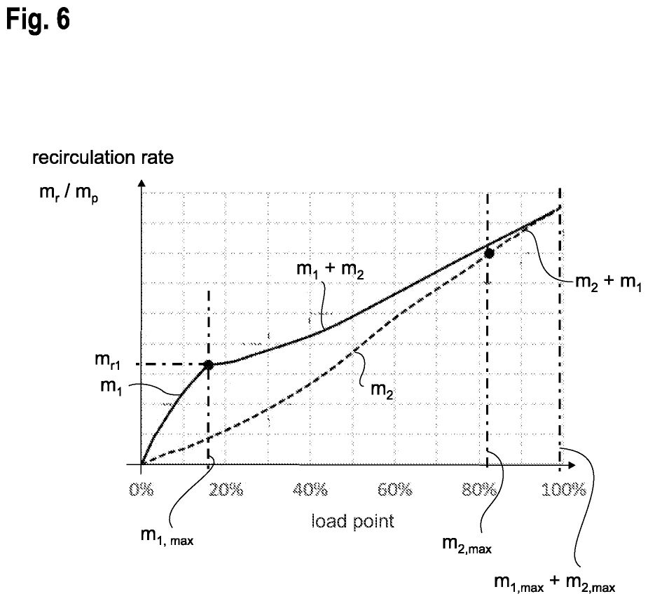

A variation of the primary gas flow rate m₁, m₂ through the first and second fuel gas valves 22, 24 and thus through the first nozzle 46 and the second nozzle 52 allows the recirculation rate to be varied within the scope of the characteristic map illustrated in FIG. 6.

To operate the ejector pump 32, only the first fuel gas valve 22, only the second fuel gas valve 24 or both fuel gas valves 22, 24 simultaneously are opened. Here, each of the fuel gas valves 22, 24 is opened individually with a predefined degree of opening or a predefined clocking in order to set a desired current primary gas flow rate m₁, m₂ through the two nozzles 46, 52.

This allows a characteristic map to be established for the recirculation rate mᵣ/mₚ, as is indicated in FIG. 6.

The use of two nozzles 46, 52 results in particular in two advantageous operating modes with regard to the recirculatable mass flow.

In a first operating mode, as the load increases, the primary gas is first introduced exclusively by the first nozzle and then additionally by the second nozzle 46, 52.

The maximum primary gas flow rate m_{1,max} of the first nozzle 46 is, for example, 10% to 30%, in particular 15%, of the maximum total primary gas flow rate m_{1,max}+m_{2,max}.

Once the maximum primary gas flow rate m_{1,max} of the first nozzle 46 has been reached, the second nozzle 52 is also activated by opening the second fuel gas valve 24 (curve m₁+m₂); in the high load range, the primary gas flow rate m₂ through the second nozzle 52 can be increased up to the maximum primary gas flow rate m_{2,max} thereof. For these primary gas flow rates, the maximum load of 100% is reached at the maximum total primary gas flow rate m_{1,max}+m_{2,max}.

Due to its smaller minimum cross-sectional area 48, operation of only the first nozzle 46 in the low load range produces a higher recirculation rate mᵣ/mₚ than operation of only the second nozzle 52 (see curves m₁ and m₂ in FIG. 6).

Also in the range up to the maximum primary gas proportion m_{2,max} of the second fuel gas valve 24, an increased recirculation rate is obtained (curves m₁, m₁+m₂ in FIG. 6) compared to an operation of the second nozzle 52 alone (curve m₂ in FIG. 6).

This results in advantages in a normal operation of the fuel cell system 10.

In a second operating mode, initially only the second nozzle 52 is operated.

A lower recirculation rate is produced here (see curve m₂ in FIG. 6). Once the maximum primary gas flow rate m_{2,max} has been reached, the first nozzle 46 is additionally activated for the upper high load range (curve m₂+m₁ in FIG. 6). This takes place here in a load range of from about 70% to 90%, in particular at 85%.

This is advantageous, for example, for a cold start of the fuel cell system 10.

In higher load ranges, in this example above 70% to 90% of the maximum total primary gas flow rate m_{1,max}+m_{2,max}, both nozzles 46, 52 of the ejector pump 32 are always operated jointly.

By individually setting the current primary gas flow rate m₁, m₂ at the respective fuel gas valve 22, 24, it is in principle possible to pass through the entire characteristic map shown in FIG. 6. For example, desired load points in the area enclosed by the curves described can be addressed by operating both nozzles 46, 52 with a current primary gas flow rate m₁, m₂ up to or below their maximum primary gas flow rate m_{1,max}, m_{2,max}.

Optionally, the maximum primary gas flow rates m_{1,max}, m_{2,max} of the two fuel gas valves 22, 24 and/or of the nozzles 46, 52 are fixedly specified by design. In a different variant, they are fixed by settings of the fuel gas valves 22, 24 by means of a control unit (not shown) of the fuel cell system 10. In general, this control unit monitors and controls the degree of opening of the fuel gas valves 22, 24 during operation of the fuel cell system 10 and thus also the current primary gas flow rate through these valves.

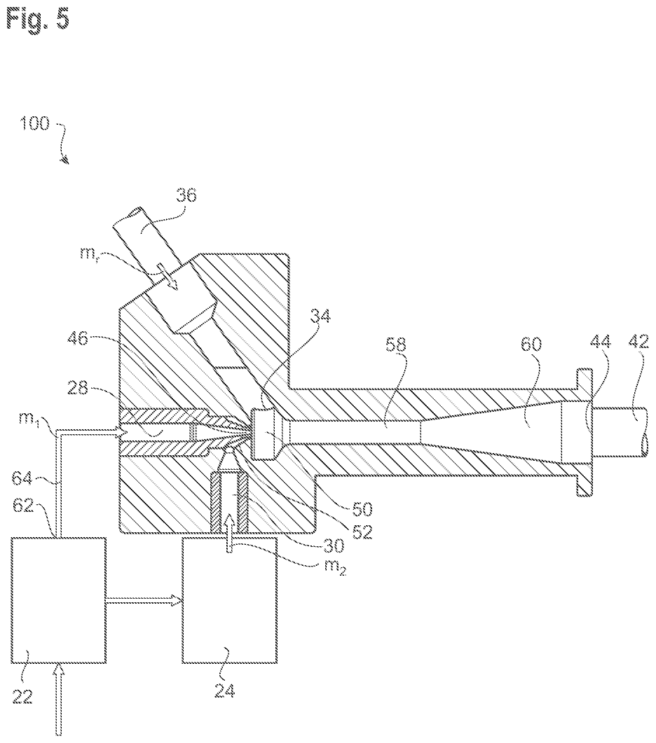

FIGS. 4 and 5 show a second variant of the fuel cell system 100.

The only difference compared to the fuel cell system 10 described above resides in the arrangement of the fuel gas valves 22, 24. In particular, the ejector pump 32 here is identical to the ejector pump 32 of the first variant.

In this variant, the first fuel gas valve 22 is configured as a shut-off valve by analogy with the shut-off valve 26 described above. Accordingly, the shut-off valve 26 is omitted.

A bypass line 68 leads from an outlet 66 of the first fuel gas valve 22 to the primary gas inlet 28, connected to the first nozzle 46, of the ejector pump 32, bypassing the second fuel gas valve 24.

The second fuel gas valve 24 is in direct fluid communication with the primary gas inlet 30 of the ejector pump 32. As in the first variant, the second fuel gas valve 24 is configured as a continuously adjustable proportional valve and/or clocked valve.

To operate the ejector pump 32, the first fuel gas valve 22 is generally open here, with the maximum primary gas proportion m_{1,max} always flowing through the first nozzle 46. The maximum primary gas proportion m_{1,max} is specified here by the minimum cross-sectional area 48 of the first nozzle 46.

When only the first nozzle 46 is operated, the recirculation rate is invariably fixed to the recirculation rate mᵣ₁ occurring at the load point at the maximum primary gas proportion m_{1,max} of the first nozzle 46 (see FIG. 6).

When the second nozzle 52 is additionally operated, the curve m₁+m₂ in the characteristic map of FIG. 6 can be passed through by varying the primary gas flow rate m₂ by the second nozzle 52.

In the examples shown here, the ejector pump includes exactly one first nozzle 46 and a single second nozzle 52. However, a plurality of second nozzles could also be provided, which are then each designed coaxially in relation to one another as ring nozzles. Each of these further second nozzles is then connected to a fuel gas valve of its own, each of which is designed analogously to the second fuel gas valve 24 and connected in parallel thereto.

All of the features of the individual embodiments and variants can be freely interchanged or combined with each other at the discretion of a person of ordinary skill in the art.

Identical reference numbers (as well as numbers increased by 100) designate identical or essentially identical or identically acting components and parts in different embodiments.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A fuel cell system comprising at least one fuel cell which includes an anode compartment and a cathode compartment, and comprising a recirculation line for anode gas which leads from a gas outlet of the anode compartment to a gas inlet of the anode compartment and in which an ejector pump is arranged, the ejector pump including a first nozzle and at least one second nozzle which is in the form of a ring nozzle arranged coaxially around the first nozzle, and comprising at least two fuel gas valves, each fuel gas valve being associated with a nozzle and controlling a supply of pressurized fuel gas to a primary gas inlet of the respective nozzle of the ejector pump.

2. The fuel cell system according to claim 1, wherein the primary gas inlet of the second nozzle opens into an annular chamber of the second nozzle.

3. The fuel cell system according to claim 1, wherein all nozzles open axially into a suction chamber which is enlarged in comparison with the outside diameter of the second nozzle and into which the recirculation line opens laterally.

4. The fuel cell system according to claim 3, wherein all nozzles open into the suction chamber at their minimum cross-sectional areas.

5. The fuel cell system according to claim 1, wherein at least one fuel gas valve is a proportional valve and/or a valve operated in a clocked manner.

6. The fuel cell system according to claim 1, wherein the ejector pump is designed such that it can be selectively operated with only one nozzle or simultaneously with a plurality of nozzles.

7. The fuel cell system according to claim 1, wherein a shut-off valve is provided which is either connected upstream of both fuel gas valves or is formed by the first fuel gas valve.

8. The fuel cell system according to claim 1, wherein all of the fuel gas valves are connected in parallel.

9. The fuel cell system according to claim 1, wherein the first fuel gas valve is connected upstream of all further fuel gas valves and a bypass line runs from the outlet of the first fuel gas valve to the ejector pump, parallel to all further fuel gas valves.

10. The fuel cell system according to claim 1, wherein the first fuel gas valve is open when the ejector pump operates.

11. A method of operating a fuel cell system, comprising at least one fuel cell which includes an anode compartment and a cathode compartment, and comprising a recirculation line for anode gas which leads from a gas outlet of the anode compartment to a gas inlet of the anode compartment and in which an ejector pump is arranged, the ejector pump including a first nozzle and at least one second nozzle which is in the form of a ring nozzle arranged coaxially around the first nozzle, and comprising at least two fuel gas valves, each fuel gas valve being associated with a nozzle and controlling a supply of pressurized fuel gas to a primary gas inlet of the respective nozzle of the ejector pump,
wherein in a low load range selectively only the first or only the at least one second nozzle of the ejector pump is supplied with primary gas and in a high load range both nozzles are supplied with primary gas simultaneously.

12. The method according to claim 11, wherein the supply of fuel gas to the respective primary gas inlet of the individual nozzles is freely controllable within the scope of a characteristic map, the characteristic map being determined by predefined maximum primary gas flow rates of the fuel gas valves associated with the respective nozzles.

13. The method according to claim 11, wherein the supply of fuel gas to the respective primary gas inlet of the individual nozzles is freely controllable within the scope of a characteristic map, the map being determined by a single curve starting at the load point established by the opening of the first fuel gas valve and the sole operation of the first nozzle, and being traversed to the maximum by a stepless opening of the second fuel gas valve up to its maximum opening degree.
